(19) United States
(12) Patent Application Publication
(10) Pub. No.: US 2015/0324726 A1
(43) Pub. Date: Nov. 12, 2015

(54) BENCHMARKING ACCOUNTS IN APPLICATION MANAGEMENT SERVICE (AMS)

(71) Applicant: International Business Machines Corporation, Armonk, NY (US)

(72) Inventors: Ta-Hsin Li, Danbury, CT (US); Ying Li, Mohegan Lake, NY (US); Rong Liu, Sterling, VA (US); Piyawadee Sukaviriya, White Plains, NY (US); Jeaha Yang, Stamford, CT (US)

(21) Appl. No.: 14/747,309

(22) Filed: Jun. 23, 2015

Related U.S. Application Data
(63) Continuation of application No. 14/688,371, filed on Apr. 16, 2015.
(60) Provisional application No. 61/980,650, filed on Apr. 17, 2014.

(51) Int. Cl. G06Q 10/06

(52) U.S. Cl. CPC G06Q 10/06393

(57) ABSTRACT

An application management service account benchmarking. An account profile is generated associated with a target account. Data associated with the target account collected and prepared for benchmarking. A benchmarking pool is formed to include a set of accounts with which to compare the target account. Operational KPIs are designed for benchmarking analysis. Measurements associated with the operational KPIs are determined for the target account and the set of accounts in the benchmarking pool. Benchmarking is conducted based on the measurements. A graph of a distance map is generated and presented on a graphical user interface. Post benchmarking analysis is performed that suggests an action to be performed for the target account.

### FIELD

The present application relates generally to computers and computer applications, and more particularly to application management services, incident management and benchmarking, for example, in information technology (IT) systems.

### BACKGROUND

As the number and complexity of applications grow within an organization, application management, maintenance, and development tend to need more effort. Effective management of application requires deep expertise, yet many companies do not find this within their core competency. Consequently, companies have turned to Application Management Service (AMS) providers for assistance. AMS providers typically assume full responsibility for many of the application management tasks including application development, enhancement, testing, production maintenance and support. Nevertheless, it is the maintenance-related activities that usually take up the majority of an organization's application budget.

### BRIEF SUMMARY

A method and system for an application management service account benchmarking may be provided. The method in one aspect may comprise generating an account profile associated with a target account. The method may also comprise collecting data associated with the target account and preparing the data for benchmarking, the data comprising at least ticket data received for processing by the target account. The method may further comprise forming, based on one or more criteria, a benchmarking pool comprising a set of accounts with which to compare the target account. The method may also comprise defining operational KPIs for benchmarking analysis. The method may further comprise computing measurements associated with the operational KPIs for the target account and the set of accounts in the benchmarking pool. The method may further comprise conducting benchmarking based on the measurements. The method may also comprise generating a graph of a distance map representing benchmarking outcome. The method may further comprise presenting the graph on a graphical user interface. The method may also comprise performing post benchmarking analysis to recommend an action for the target account.

A system for an application management service account benchmarking, in one aspect, may comprise a processor and an account data collection and profiling module operable to execute on the processor. The account data collection and profiling module may be further operable to generate an account profile associated with a target account, the account data collection and profiling module further operable to collect data associated with the target account and prepare the data for benchmarking, the data comprising at least ticket data received for processing by the target account. A benchmarking pool formation module may be operable to execute on the processor and to form, based on one or more criteria, a benchmarking pool comprising a set of accounts with which to compare the target account. A KPI design module may be operable to execute on the processor and to define operational KPIs for benchmarking analysis. A KPI measurement and visualization module may be operable to execute on the processor and to compute measurements associated with the operational KPIs for the target account and the set of accounts in the benchmarking pool, the KPI measurement and visualization module further operable to generate a graph representing a distance map that represents a benchmarking outcome. A post benchmarking analysis module may be operable to execute on the processor and to performing post benchmarking analysis to recommend an action for the target account.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 is a flowchart illustrating an AMS account benchmarking process in one embodiment of the present disclosure.

FIG. 2 shows an example of a ticket with attributes in one embodiment of the present disclosure.

FIG. 3 shows an example of ticket data distribution with incomplete data period for a particular AMS account in one embodiment of the present disclosure.

FIG. 4 shows an example of an enhanced profile containing basic account dimensions and the mined social information in one embodiment of the present disclosure.

FIG. 5 illustrates data range selection curves that indicate the volume distribution in one embodiment of the present disclosure.

FIG. 6 shows an example of KPI measurement visualization in one embodiment of the present disclosure.

FIG. 7 shows another example of KPI measurement visualization in one embodiment of the present disclosure.

FIG. 8 shows example visualization for a computed overall score in on embodiment of the present disclosure.

FIG. 9 shows an example of ticket backlog trend with the trend of ticket arrival and completion over a period of time for an example account in one embodiment of the present disclosure.

FIG. 10 shows an example of visualizing a benchmarking output in one embodiment of the present disclosure.

FIG. 11 shows another example of visualizing a benchmarking output in one embodiment of the present disclosure.

FIG. 12 shows an example GUI showing a distance map in one embodiment of the present disclosure.

FIGS. 13A, 13B, and 13C show examples of the GUI presented with a visualization graph in one embodiment of the present disclosure.

FIG. 14 illustrates example methodologies used for determining KPI-based distance measurement in one embodiment of the present disclosure.

FIG. 15 shows an example of a distance map displayed on a GUI, in one embodiment of the present disclosure.

FIG. 16 shows an example of a performance evolution in terms of an overall impression score for a particular account in one embodiment of the present disclosure.

FIG. 17 is a flow diagram illustrating a method of benchmarking accounts in application management services in one embodiment of the present disclosure.

FIG. 18 is a diagram illustrating components for benchmarking accounts in application management services in one embodiment of the present disclosure.

FIG. 19 illustrates a schematic of an example computer or processing system that may implement a benchmarking system in one embodiment of the present disclosure.

### DETAILED DESCRIPTION

Maintenance-related activities are usually faithfully captured by application-based problem tickets (aka. service requests), which contain a wealth of information about application management processes such as how well an organization utilizes its resources and how well people are handling tickets. Consequently, analyzing ticket data becomes one of the most effective ways to gain insights on the quality of application management process and the efficiency and effectiveness of actions taken in the corrective maintenance. For example, in AMS area, the performance of each account can be measured by various key performance indicators (KPIs) such as ticket volume, resolution time and backlog. These KPIs may provide insights on the account's operational performance.

An account in the present disclosure refers to a client (e.g., organization) that has a relationship with an AMS service provider. In one embodiment, techniques are provided for comparing performance of organization's information technology application management with an industry standard or other organizations' performance, e.g., benchmarking accounts are provided so as to let each account know where it stands relative to others, e.g., does an account have too many high severity tickets as compared to peers? How is an account's resource productivity? Benchmarking allows an account to establish a baseline. Benchmarking can help an account set a realistic goal or target that it wants to reach, and focus on the areas that need work (e.g., identify best practices and the sources of value creation).

A benchmarking system and methodology are presented, for example, that applies to an Application Management Service (AMS). In one aspect, a benchmarking technique, method and/or system of the present disclosure is designed and developed for AMS applications which focuses on operational KPIs, for example, suitable for service industry. In one embodiment, a methodology of the present disclosure may include discovering the right type of information for benchmarking, and allows for benchmarking an account's operational performance.

In one embodiment, the benchmarking of the present disclosure may be socially enhanced. Benchmarking allows an AMS client or account to understand where it stands relative to others in terms of its operational performance, and helps it set a realistic target to reach. A benchmarking method and/or system in one embodiment of the present disclosure may include the following modules: account data collection, cleansing, sampling, mapping and normalization; account social data mining; benchmarking pool formation and data range selection; key performance indicator (KPI) design for account performance measurement; KPI implementation, evaluation and visualization; benchmarking outcome visualization; and a post-benchmarking analysis.

Generally, benchmarking is the process of comparing an organization's processes and performance metrics to industry bests or best practices from other industries. Dimensions that may be measured include quality, time and cost.

In one aspect, a socially enhanced benchmarking system and method in the present disclosure may include a benchmarking data model enriched with social data knowledge and reusable benchmarking application history; automatic recommendation of benchmarking pool by leveraging social data; benchmarking KPI measurement; benchmarking outcome visualization; and a post-benchmarking analysis which tracks the trend of an account's benchmarking performance, recommends best action to take as well as future benchmarking targets.

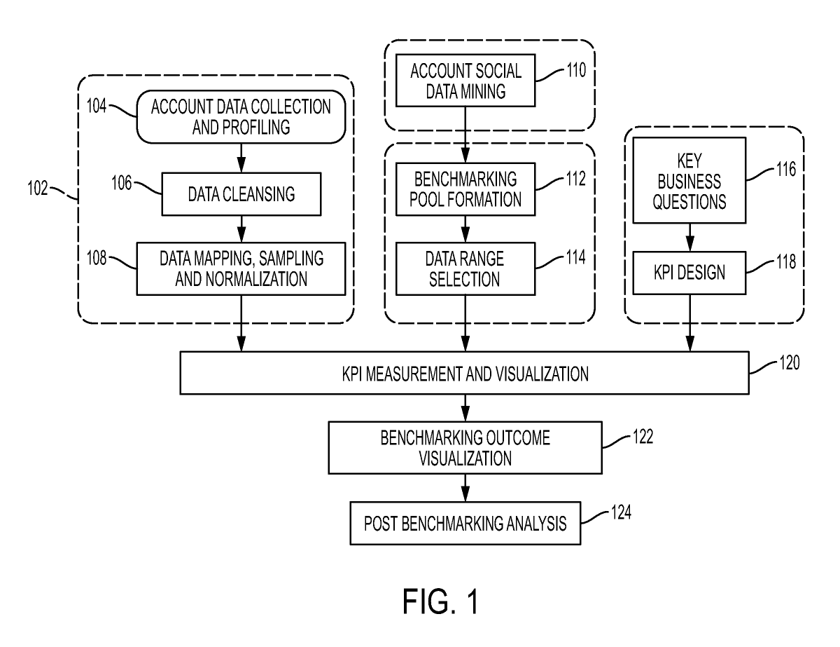

In one embodiment, a method and system of the present disclosure may benchmark accounts based on a set of KPIs, which capture an AMS account's operational performance. FIG. 1 is a flowchart illustrating an AMS account benchmarking process in one embodiment of the present disclosure. Data preparation 102 may include account data collection and profiling 104, data cleansing 106 and sampling, data mapping and normalization 108 for all accounts.

Account social data mining 110 mines an account's communication traces to identify discussion topics and concept keywords. Such information may be used to enrich the account's profile and subsequently help users to identify relevant accounts for benchmarking.

Benchmarking pool formation 112 may guide users to select a set of relevant accounts that will be used for benchmarking based on various criteria. Data range selection 114 may then identify a data range, for example, the optimal data range, for the benchmarking analysis.

KPI design 118 defines a set of operational KPIs to be measured for benchmarking analysis, guided by questions 116.

KPI measurement and visualization 120 computes the KPIs for all accounts in the benchmarking pool, as well as for the account to be benchmarked. In one embodiment, KPI measurement and visualization 120 then visualizes the KPIs side by side.

Benchmarking outcome visualization 122 presents the benchmarking statistics for available accounts all at once, for example, in a form of a graph. In one embodiment, each node in the graph represents an account, and the distance between two nodes is proportional to their performance disparity.

Post benchmarking analysis 124 tracks an account's benchmarking performance over time, recommends best action for the account to take as well as suggesting future benchmarking dimensions.

In one embodiment, accounts' social data is leveraged to identify insightful information for the benchmarking purpose. The system and method of the present disclosure in one embodiment customizes the design of KPIs for AMS accounts.

Referring to 104, for an account (e.g., when a new account is created), basic information about the account may be obtained to form its profile. Examples of such profile data include the geography, country, sector, industry, account size (e.g., in terms of headcount), contract value, account type, and others. Once the account is set up, its service request data may be collected as a data source. Service request data is usually recorded in a ticketing system. A service request is usually related to production support and maintenance (i.e., application support), application development, enhancement and testing. A service request is also referred to as a ticket.

A ticket includes multiple attributes. The number of attributes may vary with different accounts, e.g., depending on the ticket management tool and the way ticket data is recorded. In one embodiment of the present disclosure, the ticket data of an account may have one or more of the following attributes, which contain information about each ticket.

1. Ticket number, which is a unique serial number.
2. Ticket status, such as open, resolved, closed or other in-progress status.
3. Ticket open time, which indicates the time when the ticket is received and logged.
4. Ticket resolve time, which indicates the time when the ticket problem is resolved.
5. Ticket close time, which indicates the time when the ticket is closed. A ticket is closed after the problem has been resolved and the client has acknowledged the solution.
6. Ticket severity, such as critical, high, medium and low. Ticket severity determines how a ticket should be handled. Critical and high severity tickets usually have a higher handling priority.
7. Application, which indicates the specific application to which the problem is related.
8. Ticket category, which indicates specific modules within the application.
9. Assignee, which is the name (or the identification number) of the consultant who handles the ticket.
10. Assignment group, which indicates the team to which the assignee belongs.
11. The SLA (Service Level Agreement) met/breach status, which flags if the ticket has met or breached specific SLA requirement. Generally, the SLA between an organization and its service provider defines stringent requirements on how tickets should be handled. For instance, it may require a Critical severity ticket to be resolved within 2 hours, and a Low severity ticket to be resolved within 8 business hours. Certain penalty applies to the service provider if it does not meet such requirements.

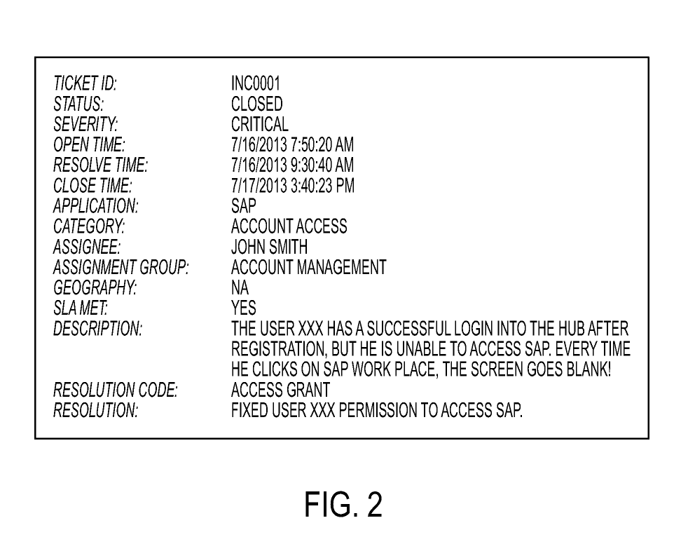

Other attributes of a ticket, which share additional information about the tickets, may include the assignees' geographical locations, detailed description of the problem, and resolution code. FIG. 2 shows an example of a ticket with a number of typical attributes.

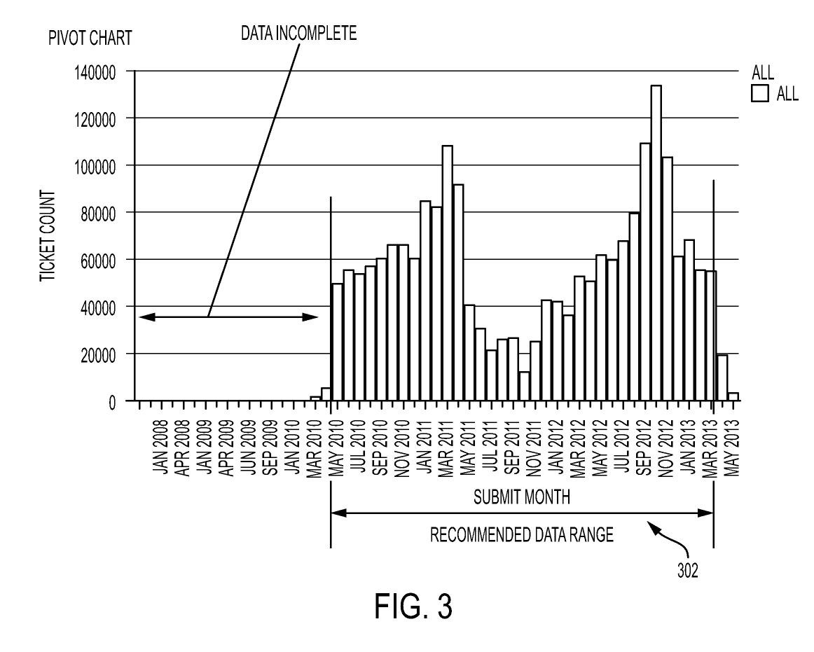

Data cleansing 106 determines the data to include or exclude. For example, data cleansing may automatically exclude incomplete data period. For instance, due to criteria used for extracting data from a ticketing tool, the ticket file may contain incomplete data for certain periods or temporal duration. FIG. 3 shows one such example for a particular account, in which the beginning data period, roughly from January 2008 to April 2012, contains very few and scattered tickets. If such incomplete data period is taken into account, the benchmarking analysis may be biased.

In embodiment, the system and/or method automatically identify the primary data range, which is subsequently recommended to use for benchmarking analysis. Several approaches may be applied for identifying such data range. For example, given a user-specified data duration (e.g., 1 year), the first approach identifies a one-year data window that has the largest total ticket volume (i.e., the most densely populated data period). This can be formulated as

$${arg max}_{i} {\sum }_{j = 1}^{12} T {V}_{ij} \qquad ( 1 )$$

where TVᵢⱼ indicates the ticket volume of the j^{th} month starting from month i.

In the second approach, the system and/or method of the present disclosure in one embodiment may attempt to identify the one-year data period that has the largest signal-to-noise ratio (SNR). This can be formulated it as

$${arg max}_{i} \frac{{μ}_{i}}{{σ}_{i}} \qquad ( 2 )$$

where μ and σᵢ indicate the mean and standard deviation of the monthly ticket volume of the i^{th} 1-year period, respectively. When a data period has continuous large ticket volumes, it will have a large SNR.

FIG. 3 shows an example of ticket data distribution with incomplete data period for a particular AMS account. In the example, recommended data range 302 may be determined based on one or more of the above-described approaches.

Data cleansing may ensure real and clean account data with reasonable amounts is used for benchmarking. In one embodiment, sandbox accounts are to be excluded. Accounts with non-incident tickets may be excluded, if the benchmarking focus is on incident tickets. Accounts containing data of very short period (e.g., 1 or 2 months) may be excluded. In one embodiment, data cleansing may automatically detect and remove anomalous data points. Anomalous data points or outliers may negatively affect the benchmarking outcome, which may be caused by sudden volume outbreak or suppression due to external events (e.g., a new release or sunset of an application). In one embodiment, such outlier data may be excluded from benchmarking, as they may not represent the account's normal behavior. In one embodiment, the following approaches may be applied to detect outliers from ticket volume distribution. 3-sigma rule: if a data point exceeds the (mean+3*sigma) value, it is an outlier. If two consecutive points both exceed (mean+2*sigma) value, they are outliers. If three consecutive points all exceed (mean+sigma) value, they are outliers. Use MVE (minimum volume ellipsoid) to find a boundary around the majority of data points and detect outliers (the mean and sigma will not be distorted by outliers). Once outliers are detected, interpolation approach may be used to regenerate their volume values, e.g., use the average of their neighboring N points as their values.

Data sampling, mapping and normalization 108 further prepares data for benchmarking. For example, data may be sampled from the account, for instance, if the account contains many years of data, before a benchmarking is conducted. The reason for sampling may be that outdated data may no longer reflect the account's latest status in terms of both its structure and performance. Moreover, which portion of data to keep or drop may be determined based on benchmarking context and purpose as well. For instance, for benchmarking accounts in cosmetics industry, it may be important to include end-of-year data as this is the prime time for such accounts. On the other hand, for fast-growing accounts, only their most recent data may be kept. As another example, the latest few years of data may be sampled out of long history of data.

Data mapping 108 standardizes data across accounts. As different accounts may use different taxonomies to categorize or describe their ticket data, appropriate data mapping may ensure the same “language” across accounts. For example, the languages used by different accounts may be standardized, for instance, different terminologies used by different accounts to refer to the same item. For instance, some accounts use severity to indicate the criticality or urgency of handling a ticket, while others may choose to use urgency, priority or other names. Data mapping 108 standardizes these terminologies so that benchmarking may be conducted with respect to the same ticket attributes. In one aspect, account-specific attributes, which cannot be mapped across all accounts may be skipped or not used for benchmarking. Examples of data mapping may include mapping Account A's “severity” attribute whose values are taken from [1, 2, 3, 4], to Account B's “severity” attribute whose values are taken from [critical, high, medium, low]; mapping all accounts' applications to a high-level category (e.g., database application, enterprise application software, and others). One or more predetermined data mapping rules associated with data attributes may be used in data mapping.

The data or values for the mapped ticket attributes across accounts may be normalized. The reason is that while two accounts (e.g., A and B) have the same attribute, they could have used different values to represent the same attribute. For instance, Account A may use “critical, high, medium and low” to indicate the ticket severity, while Account B could have used “1, 2, 3, 4 and 5” for severity. Normalizing at 108 ensures that all accounts use the same set of values to indicate ticket severity so that the benchmarking can be appropriately and accurately conducted. One or more predetermined data normalization rules associated with data attributes may be used in normalizing data.

Data normalization may ensure that the benchmarking accounts all use the data from the same period (e.g., the same year) or the same duration. Data normalization provides for accurate benchmarking, for example, for accounts that have seasonality and trends.

In one embodiment, data mapping and normalizing may be performed automatically. In another embodiment, data mapping and normalizing may be performed semi-automatically using input from a user, for example, an account administrator or one with the right domain knowledge and expertise. In one aspect, mapping and normalization may be done once when an account uploads its first data set. All subsequent data uploads may not need re-mapping or re-normalization.

Account social data mining 110 mines social knowledge to assist in benchmarking. A majority of enterprises have adopted some sort of social networks to enable workers to connect and communicate with each other. Discussions among workers contain insightful information about the account, for instance, they could be discussing challenges that the account is currently facing, the specific areas that need particular help, actions that can be taken to remedy certain situations, or future plans about the company growth. Such enterprise-bounded social data may be mined to gain deeper knowledge and understanding about each individual account in various aspects.

For example, the following two types of social data may be explored.

1. The communications among people within the same account with respect to various aspects of the account performance, for instance, the account's specific pain points, SLA performance, major application problems/types, and others. Emails, wikis, forums and blogs are examples of such communication traces.
2. The communications among people across different accounts, who may have talked due to their mutual interests, common applications, similar pain points, and others.

The system and/or method in one embodiment apply text mining tools to analyze those account social data and extract various types of information, for example, such as:

1. The topic of the discussion, based on which the system and/or method of the present disclosure classify each discussion into a set of predefined categories, e.g., account fact, issue, best practice, and others.
2. Specific concept keywords such as those related to AMS applications, technologies, and others.
3. Metadata about the discussion such as authors and timestamp.
4. Identification of the confidentiality of the discussion content, based on which the system and/or method of the present disclosure tag the extracted information to be either sharable or private.

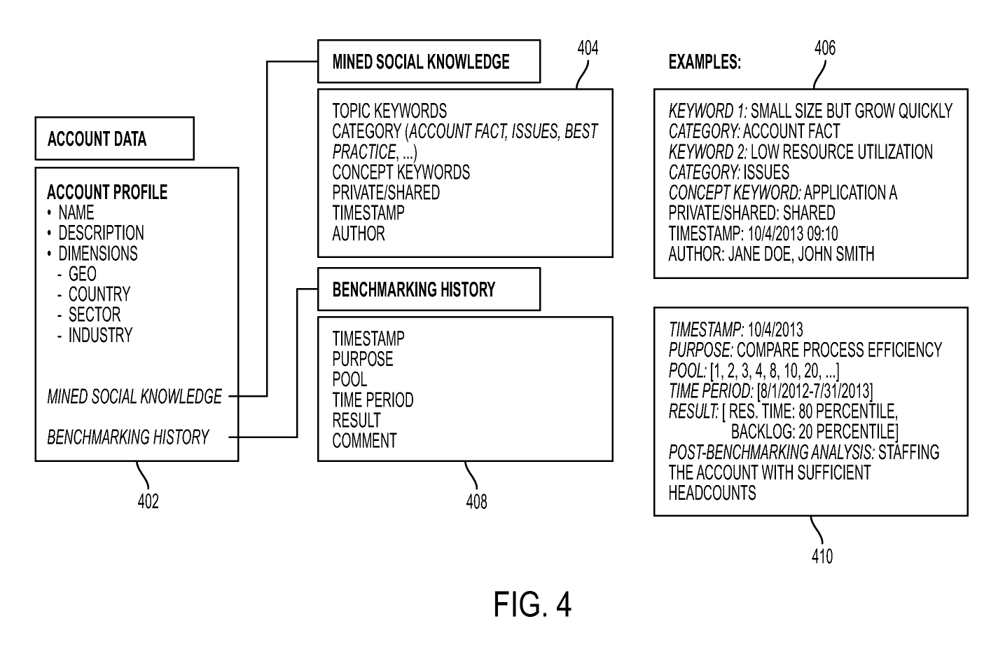

In one embodiment of the system and/or method of the present disclosure, the mined insights from such social data are populated into the account's profile. FIG. 4 shows an example of an enhanced profile 402 which contains both basic account dimensions and the mined social information 404 such as the topic keywords, category, concept keywords and author. Examples of these social insights are shown at 406. For instance, this account is of small size yet growing very fast according to keyword1 mined from social knowledge. According to keyword2, the example account also has some problem with its resource utilizations. The result of social knowledge mining also indicates that enterprise application software A is one of its major applications. The account profile 402 also shows benchmarking history 408, examples of which are shown at 410. In one embodiment, information that is account confidential is not populated into the profile. In one embodiment, one more source of social data may include an account's benchmarking history: e.g., what was the benchmarking purpose, what was the pool and what was the outcome.

Referring to FIG. 1, benchmarking pool formation 112 and data range selection 114 define a benchmarking pool in one embodiment of a method and/or system of the present disclosure. To benchmark an account (e.g., Account X), the system and/or method in one embodiment defines a set of accounts against which the account will be benchmarked. These accounts subsequently form a benchmarking pool for Account X. In one embodiment, the following three types of account profiling data may be used to form the benchmarking pool, for example, the types of account profiling data provide ways/dimensions to identify benchmarking accounts:

1. The basic account dimensions, that is, geography, country, sector and industry. For instance, assume that X is an account in Country Y in the Banking industry and it is desired to see where this account stands relative to other accounts in the same industry. The following selection criteria, “(sector=Financial Services) and (industry=Banking)” may be used to accomplish this. Another example of a selection criteria may include, “(location=Country Y) and (industry=Insurance)” for selecting a pool by geography (e.g., Country Y) and industry that is related to an insurance industry.
2. The mined social knowledge, such as the account size, applications and technologies. For instance, assume that X is concerned about its operational performance on handling its Application A (e.g., enterprise application software such as SAP), then a pool of accounts whose major applications are also Application A may be formed. For example, a selection criterion may be specified as “application=Application A”. The social data within and among accounts may be leveraged as a way/dimension to assist forming the benchmarking pool.
3. The benchmarking history. The historical benchmarking data is a good source of information, as it tells when and what types of benchmarking that Account X has conducted in the past, which accounts were compared against, and what were the outcomes. The historical benchmarking data may also contain the actions that Account X has taken after the benchmarking to improve certain aspects of its performance. FIG. 4 at 408 shows an example of such benchmarking history data.

The benchmarking data may be in both structured and unstructured data formats. For instance, the benchmarking goal and the pool of accounts may be in structured format, while the benchmarking outcome and the post analysis are in free text format. To extract information from such structured and unstructured format data, the system and/or method of the present disclosure in one embodiment may apply different approaches. The extracted information from historical benchmarking data is populated to the account's profile, as shown in FIG. 4 at 408. The populated account profile may provide users a 360-degree view of the account.

Such benchmarking history data is used to guide users to identify accounts for the new round of benchmarking. For instance, if Account X wants to benchmark with some accounts again in terms of its process efficiency, it can achieve this by specifying a selection criterion as “(Benchmarking purpose=Process Efficiency) and (Previously benchmarked accounts=Yes)”.

The selection criteria for defining a benchmarking pool may be generated automatically based on the account's individual profile data, for example, which may be unique to the account. In another aspect, a user may be presented with a graphical user interface (GUI), for example, on a display device, that allows the user to select one or more criteria, e.g., based on the types of account profile data discussed above. The GUI in one embodiment may present the various aspects of Account X as discovered and populated into its profile data, allowing the user to select by one or more of the information in the profile data for defining a benchmarking pool.

The selection criteria specified for defining benchmarking pool may be combined together, e.g., through a web GUI to retrieve corresponding accounts from an account database. The retrieved corresponding accounts form the benchmarking pool for Account X.

An example of using the mined social knowledge to assist benchmarking pool formation is described as follows. Selection criteria may be obtained, the selection criteria specified along one or more of the following factors: account dimensions, mined social knowledge and benchmarking purpose keywords, benchmarking history. A user may turn on or off each criterion to refine the benchmarking pool, for example, via a GUI. As an example, generating benchmarking pool selection criteria may include obtaining account dimensions (e.g., country=X, Industry=Y); obtaining the mined social knowledge and benchmarking purpose keywords of the account, and for example, their synonyms as defined in custom synonym dictionary or WordNet synonyms, e.g., >>>wn.synset(‘process.n.01’).lemma_names [‘procedure’, ‘process’]; and obtaining benchmarking pool from past benchmarking applications. A benchmarking database may be queried to find accounts satisfying the selection criteria.

Data range selection 114, in one embodiment selects time range or filters data ranges for benchmarking. For example, data range selection 114 in one embodiment defines a common primary data period for all accounts, for instance, as accounts in the pool could have very different data ranges. For example, given volume distributions of all benchmarking accounts over time, the system and/or method of the present disclosure may use the approaches as formulated in Equations (1) or (2) to determine the starting and ending dates of such primary period as a selected time range. The selected data range may be applied to all accounts in the pool.

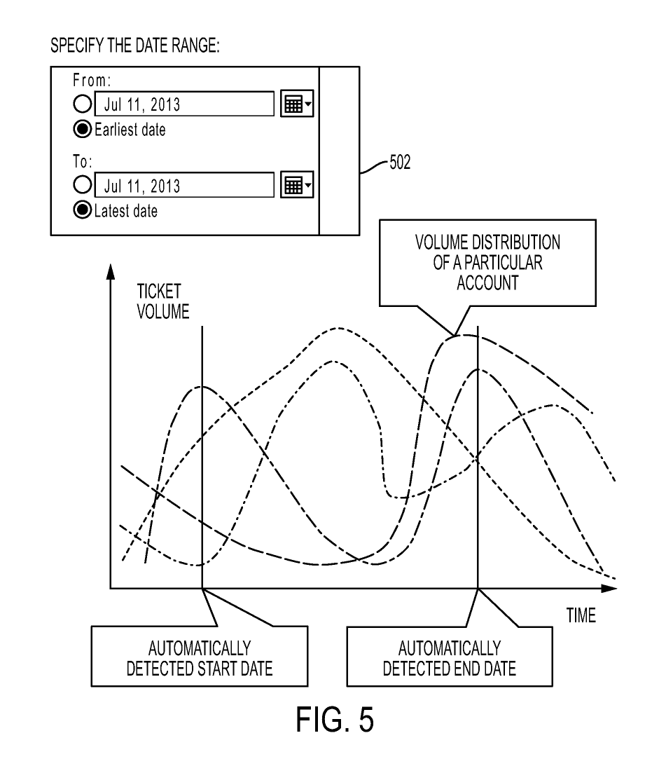

FIG. 5 illustrates such process, where each curve indicates the volume distribution of a particular account. In one embodiment, data range selection 114 may include selecting the entire data range for benchmarking without any filtering. In another embodiment, the account can take a two-step approach. For instance, in the first step, it uses all available data for benchmarking; then based on the outcome, it can adjust the data range, and conduct another round of benchmarking in the second step.

For example, to select a time range, data range selection 114 may automatically detect the most densely populated data period in the benchmarking pool, for instance, automatically detect the data period that has the largest total ticket volume of all benchmarking accounts, given the time period length. For instance, a moving average approach may be used to identify such period, for example, given specified data duration (e.g., 1 year, 2 year). Another example, the variation coefficient approach as described above in Equation (2) may be used. In one aspect, a user may be allowed to specify the data duration. In another aspect, the data duration may be determined automatically (e.g., based on the available data). In another aspect, data range selection 114 may allow a user to specify a particular data range so that only the data within that range is used for benchmarking. Yet in another aspect, data range selection 114 may allow a user to adjust the selected time range (starting and ending dates), e.g., whether automatically determined or specified by a user, in a visual way. For instance, the GUI shown at FIG. 5 may include a user interface element 502 that allows a user to adjust or enter the time range for data.

Based on the benchmarking pool defined, a set of KIPs may be measured to compare the performance between the benchmarking accounts and the current or target account (also referred to above as account X). Referring to FIG. 1, KPI design 118 in one embodiment determines a set of operational KPIs used for account performance benchmark. In determining the set of operational KPIs, the system and/or method of the present disclosure in one embodiment take into account questions 116, e.g., the key business questions, which the benchmarking analysis is trying to answer. These questions 116 guide the KPI design 118. The questions are related to the concerns an AMS team may have regarding the AMS. Examples of the questions may include:
How is my account doing relative to a “similar” account? Can I compare my account with others in terms of ticket volume, backlog, ticket closing rate, etc. and how?
Is my resolution time for Critical severity tickets normal? Is closing Critical severity tickets within one week acceptable?
How to compare the performance of different ticket resolving groups? Is my team in location A doing as well as Company B's team in location B on resolving Application A tickets?
How's the ticket distribution on my major applications? Is it normal that 20% of my tickets are coming from 80% of applications?
How are my resources utilized as compared to others in the same industry? What is the average resource utilization rate in industry C? Is 60% a normal rate for resolving Application A tickets?
Is my SLA performance comparable to others in a similar industry? Is it acceptable to achieve a 90% SLA met rate for Critical severity tickets?
How's a turnover rate as compared to others in the same industry? Do I have resources for the given ticket volumes and SLA requirements? Is it acceptable to have an average D % of turnover rate?

Based on the questions, the type of KPIs to focus on may be determined. For example, a set of KPIs may include those that measure account's ticket volume, resolution time, backlog, resource utilization, SLA met/breach rate and turnover rate. The KPI measurements may be broken down by different dimensions such as severity and application.

KPI measurement and visualization 120 measures and visualizes the set of KPIs. The following illustrates examples of specific KPIs that are measured and assessed for account benchmarking. Example KPIs include those that are related to account's ticket volume, resolution time and backlog.

KPI 1: Percentage of Ticket Volume by Severity

An example KPI measures the ticket volume percentage breaking down by severity. This KPI measurement allows for accounts to understand the ticket volume proportion of different severity, thus to have a better picture of how tickets are distributed, and to assess if such distribution is reasonable.

TABLE 1
An output of KPI 1 measurement, where Account
X indicates the account to be benchmarked.

| | Account X | | Benchmarking Pool | |
|---|---|---|---|---|
| | | Confidence | | Confidence |
| Severity | Percentage | Limits | Percentage | Limits |
| Critical | 5% | 7-9% | 3% | 1-4% |
| High | 12% | 10-14% | 10% | 5-15% |
| Medium | 20% | 18-22% | 15% | 9-21% |
| Low | 63% | 66-70% | 72% | 62-78% |

As an example, Table 1 shows an output of this KPI, where Account X indicates the account to be benchmarked. For each severity level, e.g., Critical, the system and/or method of the present disclosure may measure the volume percentage of its tickets, along with a confidence limit. Specifically, denote the volume percentage by pᵢ, where i={critical, high, medium, low}, the system and/or method of the present disclosure may measure pᵢ as

$${p}_{i} = \frac{T K {V}_{i}}{{\sum }_{i} T K {V}_{i}} \qquad ( 3 )$$

where TKVᵢ indicates the total ticket volume of Severity i of Account X or all accounts in the pool. To measure the confidence limit of each pᵢ, the system and/or method of the present disclosure may calculate its lower limit 11 and upper limit ul as follows:

ll=max(0,pᵢ−λ×\sqrt{pᵢ×(1−pᵢ)/n}) (4)

and

ul=min(0,pᵢ+λ×\sqrt{pᵢx(1−pᵢ)/n}) (5)

where n is the sample size indicating the total number of tickets in the benchmarking pool or Account X. λ is a constant which equals 1.64 if a 90% confidence is desired; otherwise, it is 1.96 for the 95% confidence. Generally, the smaller the confidence limit, the more confidence there is on the percentage measurement.

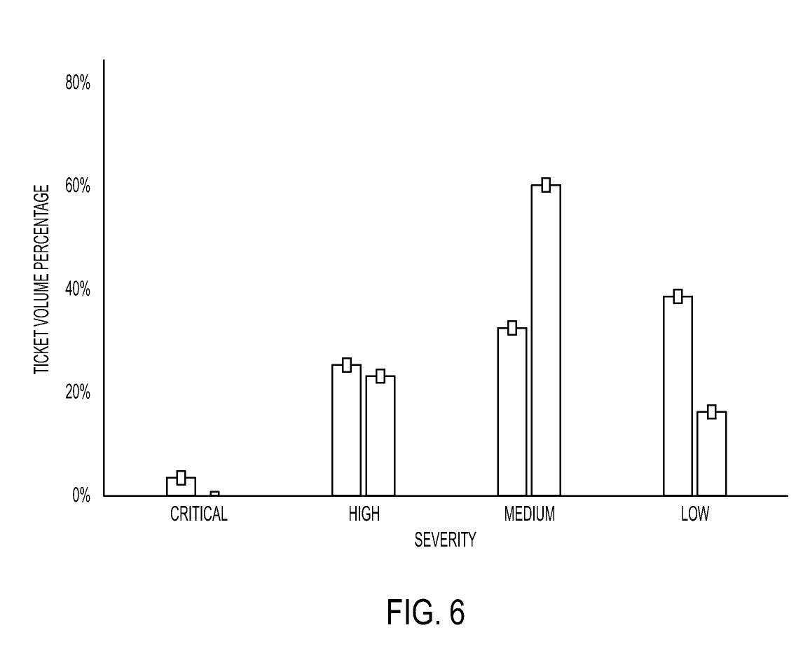

FIG. 6 shows the visualization of benchmarking output based on KPI 1 in one embodiment of the present disclosure. Bars are shown side-by-side for comparison. Left side bar (e.g., color coded blue) represents the volume percentage of the benchmarking pool and the right side bar (e.g., color coded red) represents the volume percentage of Account X. The confidence limit information is shown as the narrower vertical column on the top of each bar. By presenting the KPI output this way, one can easily compare the performance of Account X against the pool. For instance, it can be seen from this figure that Account X has a much smaller portion of Critical tickets than the pool, which is a good sign since Critical tickets tend to have a much stricter SLA requirement. On the other hand, it is seen that Account X has a much larger portion of Medium severity tickets, which may lead the account team to assess its complication on the SLA fulfillment.

KPI 2: Resolution Time

Another example KPI measures account performance in terms of resolution time. Here, resolution time is defined as the amount of elapsed time between a ticket's open time and close time. Statistics on resolution time usually reflects how fast account consultants are resolving tickets, which is always an important part of SLA definition.

An embodiment of the system and/or method of the present disclosure apply a percentile analysis to measure account's ticket resolution performance. Specifically, given Account X, the system and/or method in one embodiment first sort all of its tickets in the ascending order of their resolution time. Then for each percentile c, the system and/or method in one embodiment designate its resolution time (RT_{c}) as the largest resolution time of all tickets within it (i.e., the cap). The system and/or method in one embodiment calculate the confidence limit of RT_{c}. Such percentile analysis can be conducted either for an entire account (or the consolidated tickets in the pool), or a ticket bucket of a particular severity. Table 2 shows a KPI2 output where only Critical tickets have been used in the analysis for both Account X and the benchmarking pool.

TABLE 2
An output of KPI 2 measurement using Critical tickets, where
Account X indicates the account to be benchmarked.

| | Account X | | Benchmarking Pool | |
|---|---|---|---|---|
| | Resolution | Confidence | Resolution | Confidence |
| Percentile | Time (hrs) | Limits (hrs) | Time (hrs) | Limits (hrs) |
| 10% | 2.0 | 1.2-3.4 | 1.2 | 0.5-3.2 |
| 20% | 3.5 | 3.1-4.0 | 4.3 | 3.5-6.1 |
| 50% | 6.0 | 4.1-9.6 | 6.4 | 4.1-8.5 |
| . . . | | | | |
| 90% | 21.5 | 18.5-25.4 | 10.8 | 8.2-20.4 |

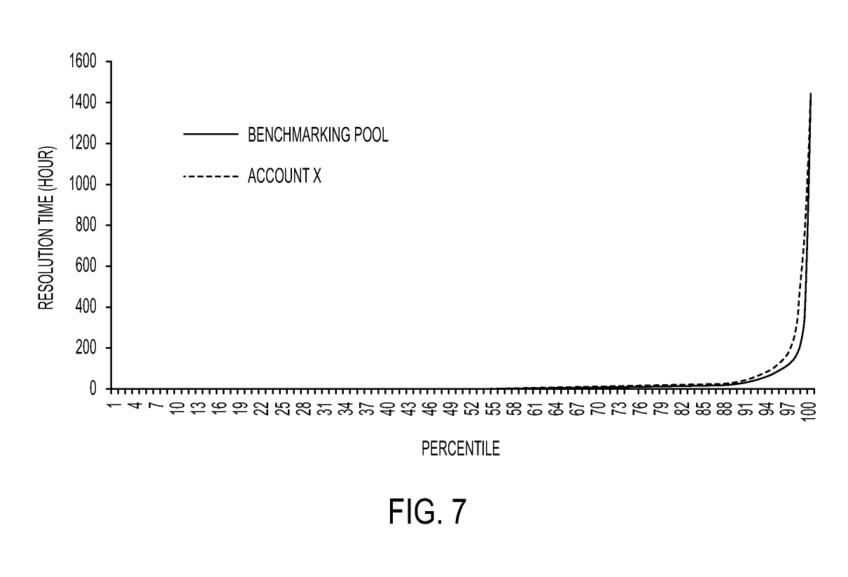

In Table 2, the resolution time may be measured as follows: 1. Sort the resolution times of all tickets in ascending order; 2. The r-th smallest value is the p=(r−0.5)/n th percentile, where n is the number of tickets. FIG. 7 shows an example of the visualization of benchmarking output based on KPI 2 using High severity tickets. The confidence limits are not shown here for clarity purpose. From the figure it is seen that the majority tickets (e.g., the top 60%) can be resolved within a short time frame, and it is really the bottom 10% that have taken a significant amount of resolution time.

The confidence limits of RT_{c} for each percentile c for Account X may be measured in one embodiment according to the following steps.

1. Sort all tickets in the ascending order of their resolution time. Denote the total number of tickets (i.e., the sample size) by n.

2. For each percentile c, set the lower limit of RT_{c} as the resolution time of the (r+1)^{th} ticket, where r is the largest k between 0 and n−1, such that

$$b ( k ) \leq \frac{α}{2} \qquad ( 6 )$$

Here, α equals 0.1 for a 90% confidence limit and 0.05 for 95% confidence. b(k) is the cumulative distribution function for a Binomial distribution, and is calculated as

$$b ( k ) = {\sum }_{i = 0}^{k} ( \begin{matrix}n \\ i\end{matrix} ) \times {c}^{i} \times {( 1 - c )}^{n - i} \qquad ( 7 )$$

3. Set the upper limit of RT_{c} as the resolution time of the (s+1)^{th} ticket, where s is the smallest k between 0 and n, such that

$$b ( k ) \geq 1 - \frac{α}{2} \qquad ( 8 )$$

If s=n, then the upper limit will be ∞.

Once the two data curves are obtained as shown in FIG. 7, the system and/or method of the present disclosure may further calculate an impression score to indicate if overall Account X outperforms the benchmarking accounts. An Impression score may be determined as follows in one embodiment.

1. Sort all tickets from Account X and the benchmarking accounts into one single ranked list in the ascending order of their resolution time. The top first ticket gets rank 1, the second ticket gets rank 2, and so forth. Tie tickets get the average rank.

2. Denote the sample sizes of Account X by N_{X}, and the sample size of benchmarking pool by N_{B}. N_{B} includes all other accounts (other than Account X) combined. The following two parameters may be computed:

$$\begin{matrix}{U}_{x} = {R}_{x} - \frac{{N}_{x} ( {N}_{x} + 1 )}{2} \\ and & ( 9 ) \\ {U}_{B} = {R}_{B} - \frac{{N}_{B} ( {N}_{B} + 1 )}{2} & ( 10 )\end{matrix}$$

where R_{X} is the sum of the ranks of all tickets in Account X, and R_{B} is the sum of the ranks of all tickets the benchmarking pool.

The overall impression score ρ is then computed as

$$ρ = \{ \begin{matrix}1 - Φ ( \frac{{U}_{x} - {N}_{x} {N}_{B} \text{/} 2}{\sqrt{{N}_{x} {N}_{B} ( {N}_{x} + {N}_{B} + 1 ) \text{/} 12}} ) , & {U}_{x} < {U}_{B} \\ Φ ( \frac{{U}_{B} - {N}_{x} {N}_{B} \text{/} 2}{\sqrt{{N}_{x} {N}_{B} ( {N}_{x} + {N}_{B} + 1 ) \text{/} 12}} ) , & {U}_{x} > {U}_{B}\end{matrix} \qquad ( 11 )$$

where Φ is the standard normal distribution function. Based on ρ's value, the system and/or method of the present disclosure in one embodiment may conclude that if ρ>0, Account X outperforms the benchmarking accounts; if ρ=0, they have the same performance; otherwise, Account X has a worse performance.

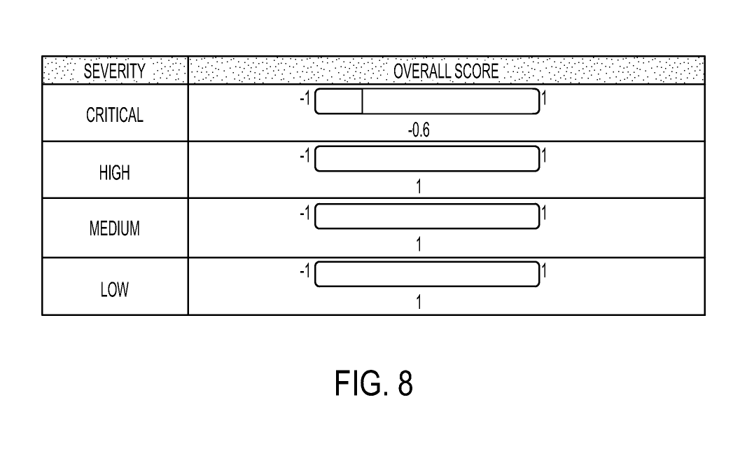

Such overall impression score helps accounts quickly understand how it is doing as compared to the benchmarking pool without going through the detailed statistics. In one embodiment of the system and/or method of the present disclosure, a bar may be used to represent the score, and colors may be used to indicate better (e.g., use green) or worse (e.g., use orange) performance. One example is shown in FIG. 8, a score is measured for each ticket bucket of different severity. It is seen that an overall score of −0.6 was obtained for the Critical tickets, meaning that the benchmarking accounts are doing better in this category. The example of FIG. 8 also shows that in the rest three severity categories, Account X has been outperforming.

KPI 3: Backlog

This KPI measures account performance in terms of ticket backlogs. Backlog refers to the number of tickets that are placed in queues and have not been processed in time. Backlog in one embodiment of the present disclosure is calculated as the difference between the total numbers of arriving tickets and resolved tickets within a specific time window (e.g., September 2013), plus the backlogs carried over from the previous time window (i.e., August 2013).

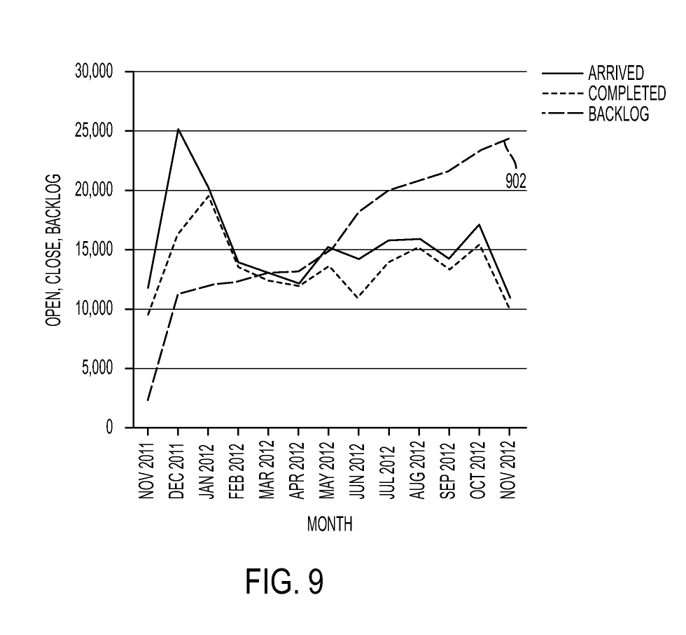

FIG. 9 shows an example of ticket backlog trend, along with the trend of ticket arrival and completion over a period of time for a particular account. The backlog (indicated by the curve 902) has been queuing up over the time, which indicates that the ticket completion has not been able to catch up with the ticket arrivals. This could be due to insufficient resources or incapability to handle the tickets.

Different mechanisms may be used to measure account performance in terms of ticket backlog. For example, the first approach may be similar to the one used for measuring the first KPI (percentage of ticket volume by severity), as formulated in Equation (3). The difference is, instead of using the total ticket volume TKVᵢ for Severity i, the sum of its monthly backlog may be used. Specifically,

$${p}_{i}^{b} = \frac{{\sum }_{j} B K {G}_{j}^{i}}{{\sum }_{i} {\sum }_{j} B K {G}_{j}^{i}} \qquad ( 12 )$$

where BKGⱼ indicates the backlog of month j for Severity i tickets.

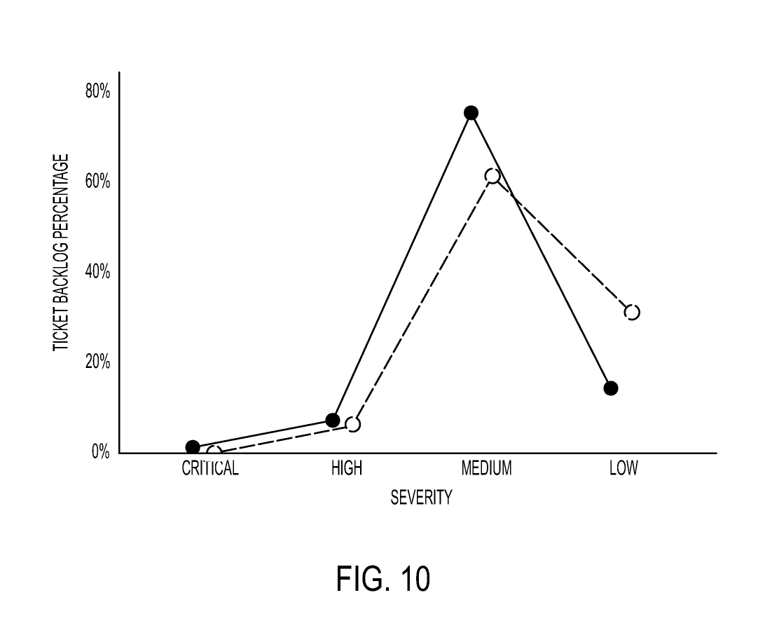

FIG. 10 shows an example of visualizing the benchmarking output using this approach. At a high level, the two curves of Account X and benchmarking pool look similar, indicating that they have similar performance. Yet at a more detailed level, e.g., for Critical severity, it can be seen that Account X has a much smaller portion of backlogs. This indicates that Account X has been handling critical tickets at a better rate than that of the benchmarking accounts. This is a good sign since SLA tends to have the most stringent requirement on Critical tickets.

Another approach is to use the backlog-to-volume ratio (BVR) to capture the account performance. This BVR measures the proportion of tickets that have been queued up. Specifically, for an account (either Account X or a benchmarking account), it is calculated as

$$B V R = \frac{{\sum }_{i} B K {G}_{i}}{{\sum }_{i} T K {V}_{i}} \qquad ( 13 )$$

where BKGᵢ and TKVᵢ indicate the number of backlogs and the total ticket volume of month i, respectively. Such measurement can be applied to either the entire account, or a ticket bucket of a particular severity.

For all benchmarking accounts, once the BVR is measured for each of them, the system and/or method of the present disclosure in one embodiment may calculate their mean (μ^{BVR}) and standard deviation (σ^{BVR}). The system and/or method of the present disclosure in one embodiment may identify the rank of Account X among benchmarking accounts in terms of their BVR in an ascending order.

Table 3 shows output of this BVR-based KPI measurement, where the BVR for each severity category has been computed. For instance, for Account X, 11% of high severity tickets were not handled in time and become backlogs. In contrast, for the benchmarking accounts, on average only 10% of their high severity tickets become backlogs. Nevertheless, Account X ranks the third in this case, meaning that only two benchmarking accounts have had a smaller BVR. The last row of table shows the average BVR of all four severity levels, weighted by their ticket volumes. To some extent, this row provides the overall impression on Account X's backlog performance as compared to the benchmarking pool.

TABLE 3
An output of KPI 3 measurement based on BVR, where
Account X indicates the account to be benchmarked.

| | |
|---|---|
| Account X | Benchmarking Pool |

| Severity | Percentage | Rank | μ^{BVR} | σ^{BVR} |
|---|---|---|---|---|
| Critical | 0% | 1 | 5% | 10% |
| High | 11% | 3 | 10% | 13% |
| Medium | 15% | 2 | 20% | 5% |
| Low | 35% | 5 | 30% | 20% |
| All | 14% | 3 | 13% | 11% |

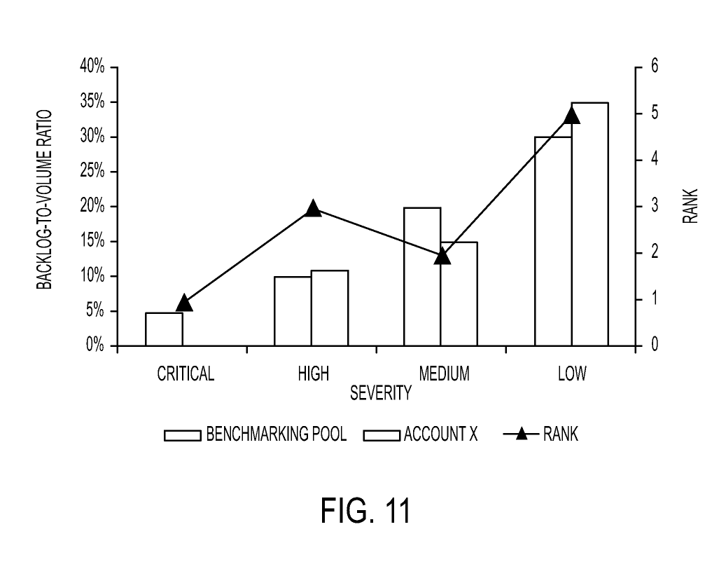

FIG. 11 shows an example of visualizing such benchmarking output, where it is shown that Account X is doing well on Critical tickets with zero BVR value, although it has a good portion of backlogs in Low severity tickets.

Referring to FIG. 1, benchmarking outcome visualization 122 transforms the benchmarking results into a visualization displayed or presented on a GUI display. Benchmarking outcome visualization 122 may provide a visualization that allows an account to understand where it stands with respect to other individual accounts. In addition to the overall performance of the pool shown by the KPI visualization described above, benchmarking outcome visualization 122 generates and visualizes information that compare an account's performance against specific accounts. In one embodiment, a system and/or method of the present disclosure present the benchmarking data or statistics for available accounts all at once in a form of a graph. A GUI may present a graph with nodes representing a target account and accounts in the benchmarking pool. The distance between accounts may indicate performance difference. Thus, in one embodiment, the graph may visualize a distance map of performance difference. The performance of the target account compared with the entire pool may be displayed. Accounts with performance superior to the target account may be highlighted. For example, an account performs better than another if it has better or equal overall impression for each KPI. The GUI may allow a user to add tags or post to any account in the pool, label an account as private or shared with tags, e.g., a private tag to Account 9 specifying “highly efficient account suitable for long time benchmarking.”

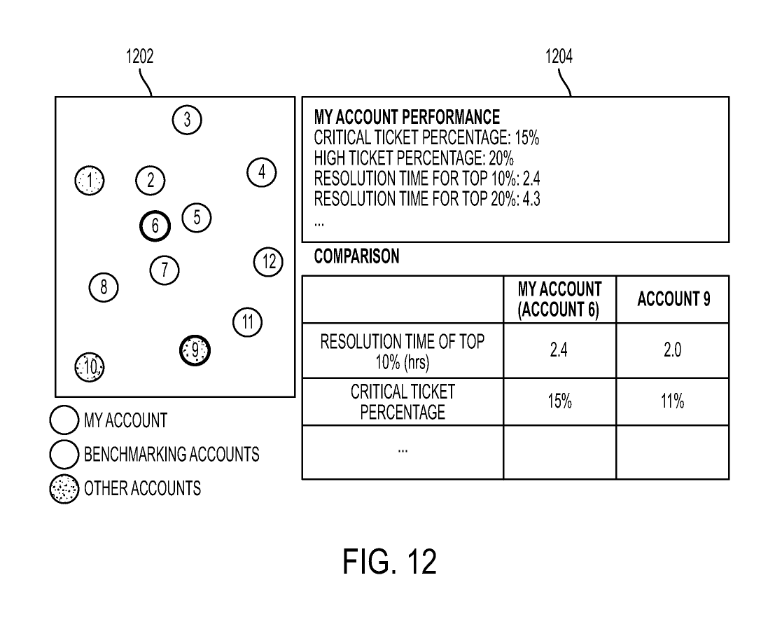

FIG. 12 shows a GUI in one embodiment of the present disclosure, where each dot indicates an account with the account number being shown in the center. The GUI may be implemented as a tool for providing benchmarking outcome visualization. When a user logs onto the tool, the layout of the graph may be automatically adjusted so that the user's account is placed at the center of the graph. Moreover, this account may be highlighted, e.g., color code, e.g., in red. For the rest of accounts, if an account was benchmarked against this account before, then that account may be highlighted in different color, e.g., in yellow; otherwise the account may be shown in another color, e.g., in green. Other visual cues may be used to differentiate the current account, and other others. In one embodiment, the size of each dot may be proportional to the number of times that it has been benchmarked for a particular purpose (e.g., process benchmarking).

In the visualization graph 1202 shown in FIG. 12, the space or distance between every two accounts is proportional to the distance metric calculated from their KPIs. In another word, the more similar the performance of two accounts, the smaller the distance between them. Various approaches can be applied to compute such distance metric. For example, the following measurements may be explored.

1. KPI-based distance measurement. Here, the system and/or method of the present disclosure may first measure the distance for each KPI between two accounts using a metric that is suitable for that particular KPI. For example, the distance for each KPI between every two accounts may be measured. Each KPI distance may be subsequently normalized to [0, 1]. Then after obtaining all KPI distances between the two accounts, they are fused together using a weighting mechanism, e.g., Euclidean distance. This provides the final distance score between the two accounts.
2. Rank-based distance measurement. Here, for each KPI measurement, the system and/or method of the present disclosure may first rank its values across all accounts and assign a ranking score to each account. As a result, each account is represented by a vector of KPI ranking scores. Then, the system and/or method of the present disclosure may measure the distance between every two accounts based on their ranking scores. The system and/or method of the present disclosure may apply multidimensional scaling to assign a position to each account.

By default, the tool may automatically show the performance of the current account in terms of KPIs in the GUI as shown on the upper right hand window 1204 in FIG. 12. If a user wants to see the performance of another account, the GUI allows the user to click on that account to view the statistics. On the other hand, if the user wants to compare the user's account against a specific account, e.g., Account 9, the user is allowed to select both Accounts 6 and 9, and the GUI may immediately show a detailed comparison, e g., in a form of a table as shown at 1206.

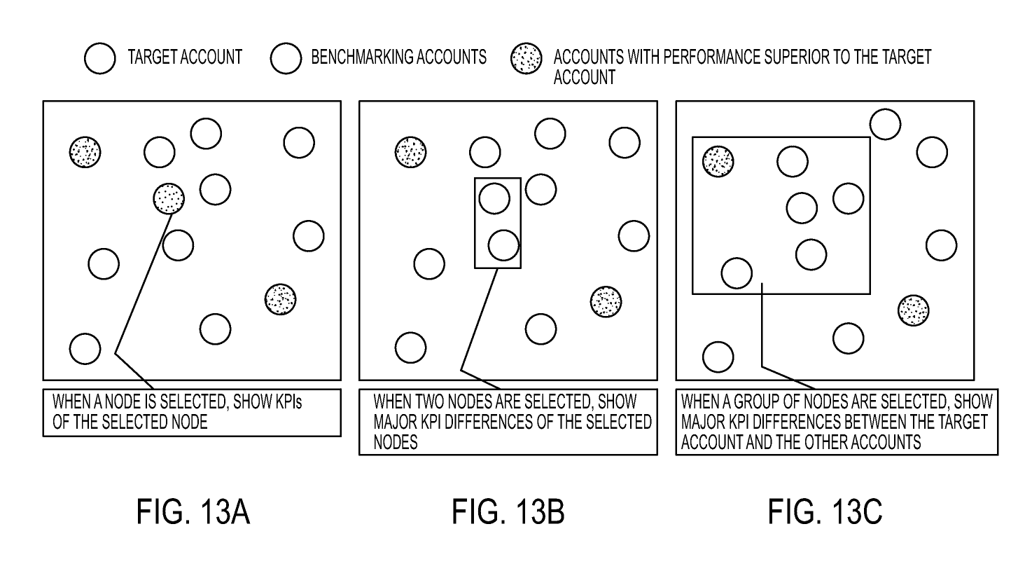

FIGS. 13A, 13B, and 13C show examples of the GUI presented with a visualization graph. For example, the benchmarking outcome may be visualized: using an individual report to visualize each KPI measurement for “benchmarking pool vs. target account”; using a distance map to visualize the overall distance among accounts in the benchmarking pool. For instance, the graph may be generated and presented such that the larger the distance between two accounts, the larger the difference in terms of their operational performance. Clustering can be performed, and the relative distance between the target account and the clusters can be observed. Referring to FIG. 13A, the GUI may allow a user to select a node. When a node is selected, the GUI may show KPIs of the selected node. Referring to FIG. 13B, the GUI may allow a user to select two nodes. When two nodes are selected, the GUI shows KPI differences of the selected nodes. Referring to FIG. 13C, the GUI may allow a user to select a group of nodes. When a group of nodes are selected, the GUI shows KPI differences between the target account and the other accounts.

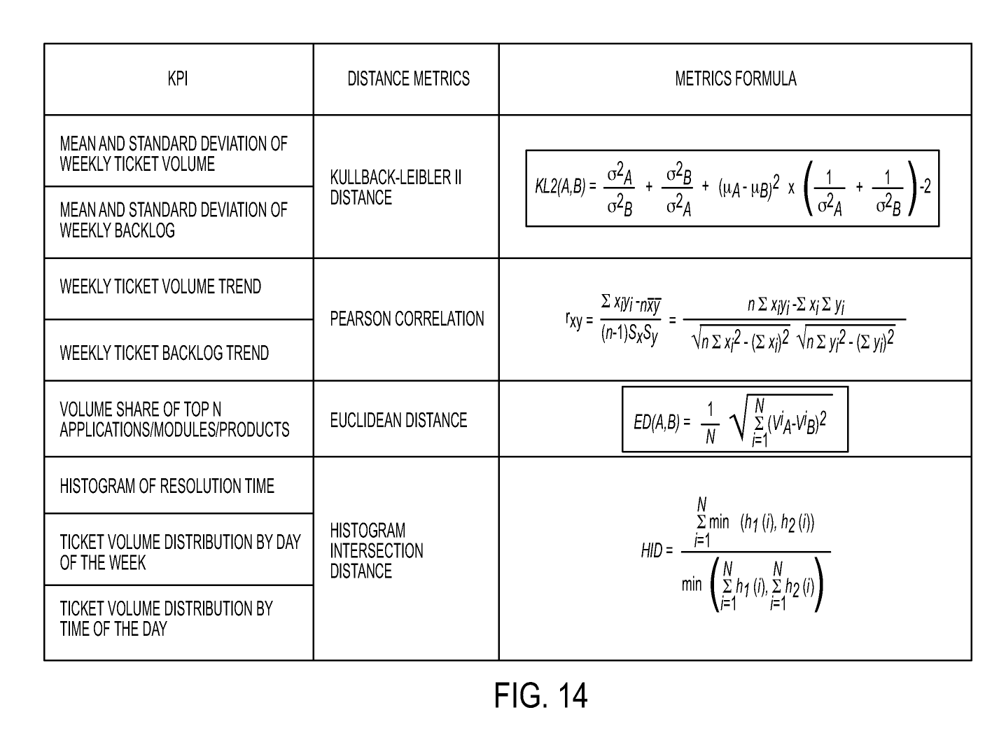

FIG. 14 illustrates example methodologies used for determining KPI-based distance measurement. In one embodiment, the system and/or method of the present disclosure may measure the distance between every two accounts for each KPI using specific distance metrics, e.g., illustrated in FIG. 14.

In one embodiment, the KPI-based distance may be measured based on a rank. For example, consider accounts A, B and C whose KPIs 1, 2 and 3 as computed as:

| | Account A | Account B | Account C |
|---|---|---|---|
| KPI1 | 0.1 | 0.2 | 0.15 |
| KPI2 | 2.0 | 2.5 | 1.80 |
| KPI3 | 25.0 | 15.0 | 25.00 |

After ranking each KPI, a matrix of rankings is obtained. Also, values can be inserted into “buckets” to determine rankings:

| | Account A | Account B | Account C |
|---|---|---|---|
| KPI1 | 1 | 3 | 1 |
| KPI2 | 2 | 3 | 1 |
| KPI3 | 3 | 1 | 3 |

The distance between each pair of accounts may be computed:

| | Account A | Account B |
|---|---|---|
| Account B | 3.000000 | 0 |
| Account C | 1.000000 | 3.464102 |

Multidimensional scaling may be applied to get the position of each account in the graph:

| | [,1] | [,2] |
|---|---|---|
| Account A | 0.8185823 | 0.46777341 |
| Account B | −2.1333132 | −0.6730921 |
| Account C | 1.3147309 | −0.40046420 |

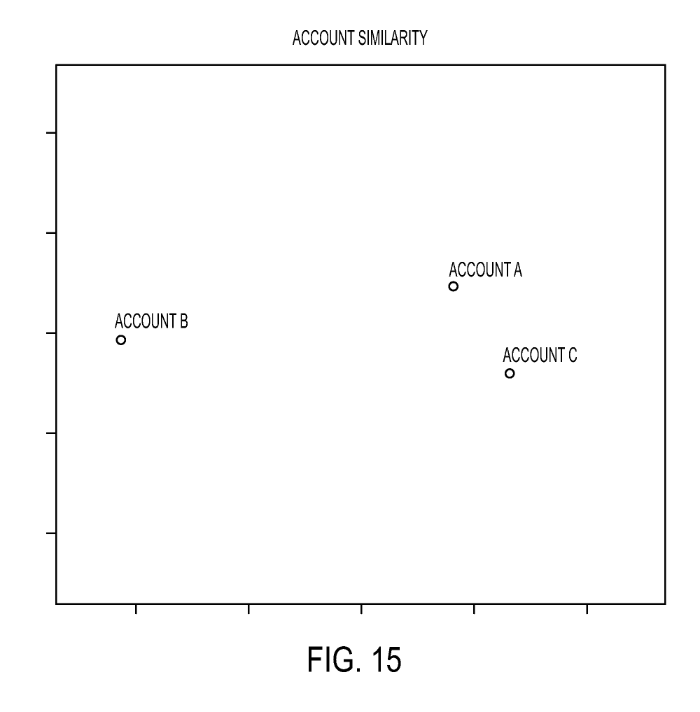

The positions are visually represented in a GUI, e.g., as shown in FIG. 15.

With the assistance of such tool in the present disclosure, users can quickly find accounts that present similar performance, which can further guide them to select appropriate accounts for benchmarking. On the other hand, for accounts that are far away from their account with very different performance, the users can apply this tool to identify the contributing factors.

Referring to FIG. 1, post benchmarking analysis 124 may be conducted, for example, after a benchmarking is performed. Examples of analysis may include:

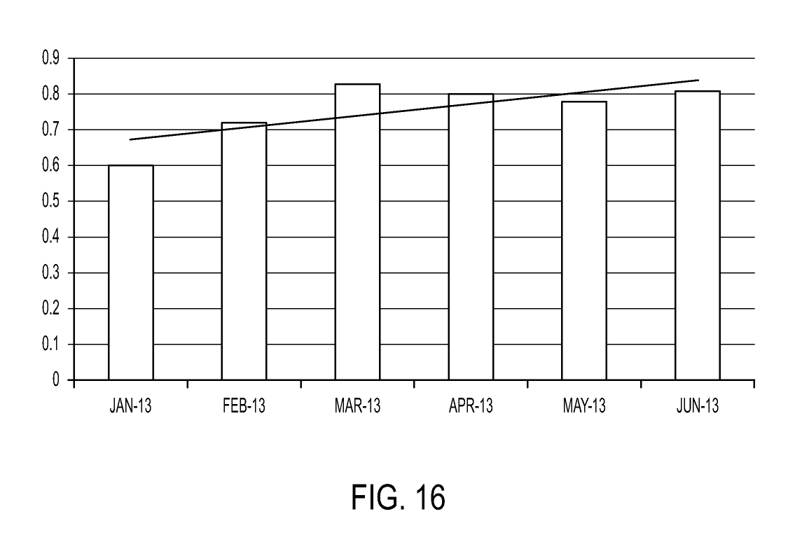

1. Calibrating the benchmarking outcome, and taking the differences due to industry, application, account size, and/or other factors, into its interpretation.
2. Recommending actions for Account X to take, based on both observed performance gap and its targeted future performance. For instance, if the benchmarking shows that Account X has a severe backlog problem, yet its overall resolution time seems to be within normal limits, this would very likely indicate that the account has a serious resourcing problem. A recommendation may be made to increase the account's resources. On the other hand, if it is observed that the account has both backlog and resolution time problems, a likely cause may be lack of skills. An example recommendation may include cross-skilling or up-skilling.
3. Tracking the evolution of the account's benchmarking performance over time, e.g., to determine if an improvement has been achieved. Alarms may be raised if a decreasing trend is observed even though the account has been taking corrective actions. The system and/or method of the present disclosure may save each account's benchmarking configuration and outcome, and hence an account's performance can be tracked over time from various perspectives. Insights and feedback can be provided based on the tracking. FIG. 16 shows an example of such performance evolution in terms of the overall impression score for a particular account. As shown, this account's performance has been gradually increasing from January 2013 to March 2013, then it stabilized for the rest of months.
4. Recommending other benchmarking dimensions. Based on the existing benchmarking outcome, the system and/or method of the present disclosure in one embodiment may potentially recommend other benchmarking dimensions for the account to consider. For instance, the next benchmarking target may be set up for the account. For instance, if the benchmarking outcome signals resource insufficiency based on large backlogs and long resolution time, a recommendation may be made to perform benchmarking related to its resources.

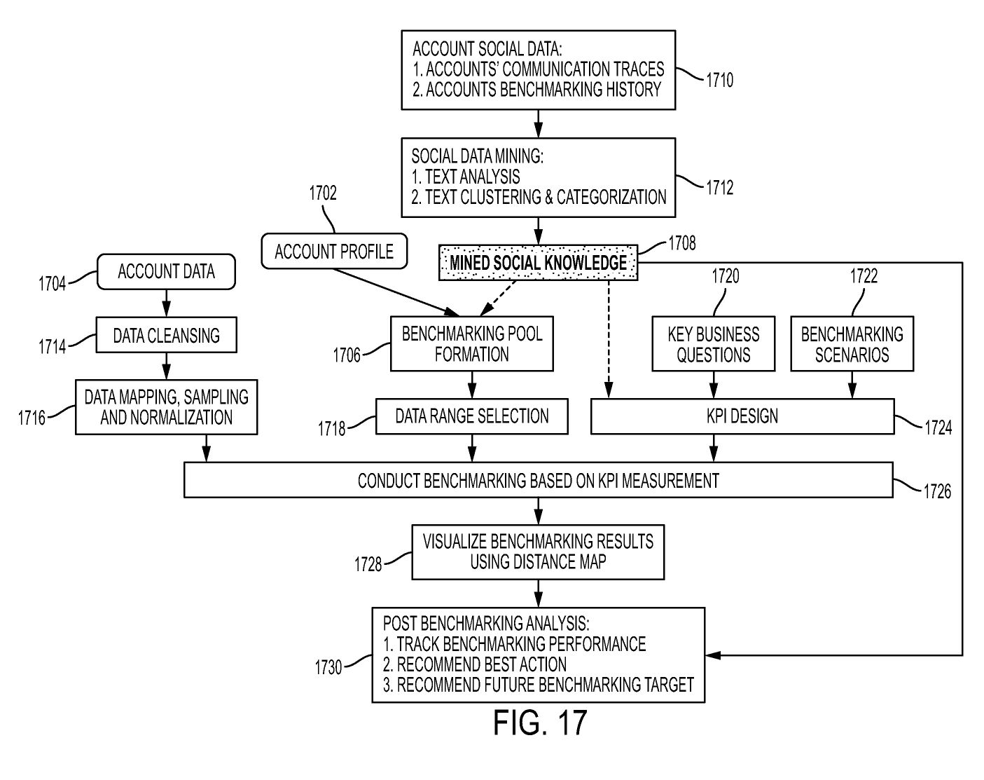

FIG. 17 is a flow diagram illustrating a method of benchmarking accounts in application management services in one embodiment of the present disclosure, for instance described above in detail. At 1702, an account profile associated with a target account (e.g., described above as Account X) is generated. Generating account profile is described above with reference to FIG. 1, for example, at 104. An example of an account profile is described above and shown in FIG. 4.

At 1704, account data associated with the target account is collected and prepared, for example, as described above, for example, with reference to FIG. 1 at 102. The data in one embodiment includes ticket data, for example, received for processing and/or processed by the target account.

At 1714, the data cleansing may determine which data to include or exclude from the account data collected at 104. Data cleansing is described above with reference to FIG. 1 at 106. At 1716, data mapping, sampling and normalization are performed, for example, as described above with reference to FIG. 1 at 108, for instance, to prepare the data for benchmarking.

At 1706, a benchmarking pool may be formed based on one or more criteria. The benchmarking pool includes a set of accounts with which to compare the target account. For instance, the benchmarking pool may be formed as described above with reference to FIG. 1 at 112. In one embodiment, the benchmarking pool may be formed also based on the mined social knowledge 1708. In one embodiment, the accounts in the benchmarking pool may change based on changes in dynamic information and/or changes of specific benchmarking purpose.

For example, at 1710, social data such as accounts' communication traces and benchmarking history may be received. At 1712, the method may include using text analytics to mine social data to identify discussion topics and concept keywords, for example, as described above with reference to FIG. 1 at 110. The mined social data 1708 may be used to generate the account profile (e.g., at 1702) and also to form the benchmarking pool at 1706. At 1718, data range selection selects a data range of the measurements to use for conducting benchmarking. For example, the data range selected may be based on most densely populated data period in the benchmarking pool. Data range selection at 1718 is also described above, for example, with reference to FIG. 1 at 114.

At 1724, operational KPIs are defined or designed for benchmarking analysis. The KPIs may be designed, for example, based on questions pertaining to the target account 1720 and benchmarking scenarios 1722. KPIs may change based on changes in benchmarking scenarios and/or specific key business questions. KPI design at 1724 is also described above with reference to FIG. 1 at 118. Measurements associated with the operational KPIs for the target account and the set of accounts in the benchmarking pool are determined or computed, and may be visualized.

At 1726, benchmarking is conducted based on the KPI measurements. For example, various comparisons may be performed between the measurements of the target account and the measurements of the benchmarking pool.

At 1728, benchmarking results are visualized, for example, using distance map. For instance, the distance map may be presented in a form of a graph on a display device for user interaction, for instance, as described above. For example, each node in the graph represents an account, and the distance between two nodes is proportional to a performance disparity between the two nodes.

At 1730, also as described above, post benchmarking analysis may be performed, for example, that recommends an action for the target account, suggests future benchmarking dimensions, and/or tracks benchmarking performance over a period of time.

Visualization, in one aspect, may also include computing an overall impression score associated with one or more of the measurements, the overall impression score comparing the target account with the set of accounts, and the overall impression score may be visualized. FIG. 8 shows an example visualization of an overall score.

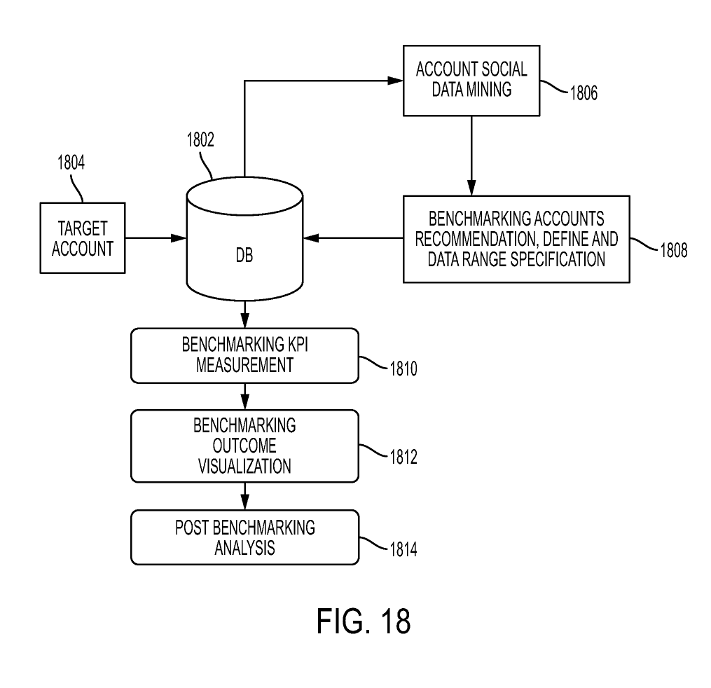

FIG. 18 is a diagram illustrating components for benchmarking accounts in application management services in one embodiment of the present disclosure. A storage device 1802 stores a database of account data, for example, target account profile data 1804, including ticket information associated with the target account. An account social data mining module 1806 mines social data, for example, communication among workers associated with the target account and other accounts. Benchmarking pool formation module 1808 forms a pool of accounts with which the target account may be benchmarked, for example, based on mined social data and account profile information. Data range may also be defined for the target account and the accounts in the benchmarking pool. KPI measurements for benchmarking are measured by a benchmarking KPI measurement module 1810. Benchmarking outcome visualization module 1812 visualizes the benchmarking results. Post benchmarking analysis module 1814 performs analysis as described above.

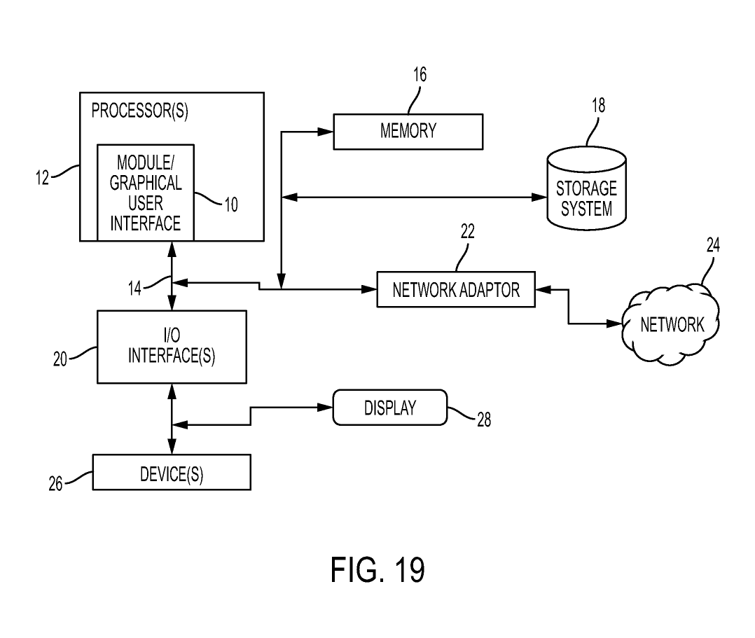

FIG. 19 illustrates a schematic of an example computer or processing system that may implement a benchmarking system in one embodiment of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 19 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include a benchmarking module/user interface 10 that performs the methods described herein. The module 10 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

We claim:

1. A method for an application management service account benchmarking, comprising:
generating an account profile associated with a target account;
collecting data associated with the target account and preparing the data for benchmarking, the data comprising at least ticket data received for processing by the target account;
forming, based on one or more criteria, a benchmarking pool comprising a set of accounts with which to compare the target account;
defining operational KPIs for benchmarking analysis;
computing measurements associated with the operational KPIs for the target account and the set of accounts in the benchmarking pool;
conducting benchmarking based on the measurements;
generating a graph of a distance map representing benchmarking outcome;
presenting the graph on a graphical user interface; and
performing post benchmarking analysis to recommend an action for the target account.

2. The method of claim 1, wherein the collecting data comprises cleansing the data, sampling the data, mapping the data and normalizing the data.

3. The method of claim 1, wherein the performing post benchmarking analysis further suggests future benchmarking dimensions, and tracks benchmarking performance over a period of time.

4. The method of claim 1, further comprising mining social data to identify discussion topics and concept keywords, wherein the mined social data is used to generate the account profile, form the benchmarking pool and assist the post benchmarking analysis.

5. The method of claim 1, wherein the benchmarking pool is formed based on the account profile, mined social data and benchmarking history.

6. The method of claim 1, wherein the set of operational KPIs capture operation performance of the target account and comprises ticket volume, ticket resolution time and backlog status, the method further comprising computing an overall impression score associated with one or more of the measurements, the overall impression score comparing the target account with the set of accounts.

7. The method of claim 1, further comprising selecting a data range to use for said conducting of the benchmark, the data range selected based on most densely populated data period in the benchmarking pool.

8. The method of claim 1, wherein each node in the graph represents an account, and the distance between two nodes is proportional to a performance disparity between the two nodes.
